(19) United States
(12) Patent Application Publication
(10) Pub. No.: US 2016/0148525 A1
(43) Pub. Date: May 26, 2016

(54) VIRTUAL OBJECTS IN A REAL 3-D SCENARIO

(71) Applicant: RHEINMETALL DEFENCE ELECTRONICS GMBH, Bremen (DE)

(72) Inventor: Klaus Wendt, Sottrum (DE)

(21) Appl. No.: 14/903,839

(22) PCT Filed: Jul. 15, 2014
(86) PCT No.: PCT/EP2014/065151

§ 371 Date: Jan. 8, 2016

(30) Foreign Application Priority Data
Jul. 15, 2013 (DE) 10 2013 213 821.0

(51) Int. Cl. G09B 9/00; G09B 5/06

(52) U.S. Cl. CPC G09B 9/003; G09B 5/06

(57) ABSTRACT

The invention relates to a method for simulating real combat operations in a scenario for exercise purposes with persons and al close range. In said method, exercise participants having exercise weapons compete against each other and the real operation events of the exercise participants during the exercise are recorded by imaging systems and computed as a 3-D model, which changes in quasi real time. A weapon effect is computed by means or object recognition of the weapon, by means of the state change and orientation during a shot, and by means of the objects located in an effective direction and injury models of said objects and is indicated. The method is characterised in that, be Fore an exercise start, for all relevant individual objects of the scenario, three-dimensional models of said individual objects in the intact, hit, and destroyed states of said individual objects and animations or the corresponding state transitions of said individual objects including the associated acoustic effects are produced and are stored in a database.

The invention relates to a method for simulating real combat operations in a scenario for training purposes with persons and at close range, training participants competing against one another with training weapons and the real actions of the training participants during the training being recorded by imaging systems and being calculated as a 3-D model which changes in quasi real time, a weapon effect being calculated by means of object recognition of the weapon, the state change and orientation during a shot and the objects in the effective direction and their injury models, and being displayed, according to the features of the precharacterizing clause of patent claim 1.

During real combat operations for training purposes with persons and at close range (for example during military urban and house-to-house combat and/or police scenarios such as rampages or hostage-taking situations), the training participants compete against one another with training weapons which, in order to harmlessly transmit the effect of the shot on the opponent, emit light signals or fire projectiles with a color fill. Hits are then detected by light sensors and are signaled to the person who has been hit using optical and/or acoustic signals or, in the other case, are simply indicated to the person who has been hit by means of color markings. In this case, the trainees must wear complicated protective clothing such as glasses, helmets and shields or must carry additional equipment such as light emitters and sensors which do not correspond to the real scenario.

This problem has already been solved in the application DE 10 2012 207 112.1 which was filed by the applicant but has not yet been published. According to the teaching disclosed therein, there is no longer any need for instrumentalization of the trainees and the training environment and no longer any need to change the training weapons. The real actions are recorded by imaging systems and are calculated as a three-dimensional model (3-D model) which changes in quasi real time. In this case, the weapon effect is calculated by means of object recognition of the weapon, the state change and orientation during the shot and the objects in the effective direction and their injury models, and is displayed.

During the gunfight training at close range described at the outset, there is a need for a correspondingly correct reaction from the person who has been hit (falling over, collapsing, etc.) in the case of a hit for the further realistic progression of the training actions. For this purpose, the person who has been hit must notice the hit and must deliberately show the associated reaction which is previously agreed where possible. During the situations which are very demanding both psychologically and physically and take place quickly, it may happen that this reaction does not take place correctly or takes place too late or not at all, confuses the person shooting as a result and distorts the training action in an unrealistic manner.

The invention is based on the object of providing a method which is improved in comparison with the prior art. In particular, the method is intended to reduce the amount of effort and to increase the effectiveness of the simulation.

This object is achieved by means of the features of patent claim 1.

The invention provides that, before the start of training, three-dimensional models of all relevant individual objects of the scenario in their intact, hit and destroyed states and animations of the corresponding state transitions including the associated acoustic effects are generated and stored in a database.

In addition to the teaching described in DE 10 2012 207 112.1 for example, the solution to this problem therefore involves, before the start of training, generating 3-D models of all relevant individual objects of the scenario, such as participants, weapons, items of equipment, furniture, etc., in their intact, hit and destroyed states and animations of the corresponding state transitions including the associated acoustic effects and storing them in a database.

One development of the invention provides that the noises during the training situation are recorded in a surround sound recording method using at least one microphone, in particular a plurality of microphones, in the scenario.

The noises during the training situation are therefore recorded in a suitable surround sound recording method using at least one microphone, in particular a plurality of microphones, in the scenario. When using the computer system disclosed in DE 10 2012 207 112.1, said system is expanded with a multichannel audio/video transmitting/receiving system.

The present invention can, but need not, be based on the subject matter of the invention in the application DE 10 2012 207 112.1 and be used in combination with the system disclosed therein. However, use with any desired alternative system is also conceivable provided that said system is compatible with the present invention.

In one development of the invention, the training participants additionally wear wireless transmitting/receiving units for image and sound in the form of glasses with earphones and a combination of suitable small and fast display systems (video glasses, retina projectors or the like) with video cameras directed in the viewing direction. This device combination is constructed such that it blocks the view into the real scenario and hides the original noises.

The further refinements of the method according to the invention are stated in the further subclaims which are described below in connection with their respective advantages.

The 3-D scenario model which is generated by one or more central computers and in which the training participants themselves move is displayed to the training participants in a tailor-made manner in terms of size and perspective and in real time using the display systems, and the matching sound effects for acoustic orientation are played in via the earphones in a surround sound method.

In this case, the cameras worn by the observer are preferably used to additionally record the scenario directly in front of the trainee's eyes if the trainee himself conceals the scenario from the imaging system, as disclosed, for example, in DE 10 2012 207 112.1.

Furthermore, the cameras are preferably used as a very accurate aid in order to determine the observer's viewing direction and to generate the corresponding view of the 3-D model in a tailor-made manner and to display it in the helmet display if the calculation from the position and stance of the trainee in the 3-D model is not sufficient for this.

For their orientation and basis for action, the participants therefore do not use the real image but rather the photorealistic 3-D model of the scenario with the corresponding sound effects which is presented to them by the central computer(s).

Since the model representation shown initially corresponds to the actually existing world, the corresponding objects therein can be touched, moved and listened to by the training participants.

The scenario can be modified in any desired manner with the aid of the stored 3-D models. In the case of a calculated hit of a flowerpot for example, the computer(s) show(s) the shattering shards, persons who have been hit are replaced with avatars behaving in a corresponding manner, and, in line with this, the corresponding noises are respectively played in.

This optical illusion is realistic for the training participants as long as they do not come into contact with replaced objects or their originals. However, this is not the case for most of the scenarios mentioned above.

In one preferred embodiment, apart from the person to be trained, all other participants, such as separate forces, opponents, animals (for example watchdogs) or the like, are completely represented by artificial performers (avatars). The latter are controlled by means of artificial intelligence according to the training objective and the trainee's action.

According to another preferred embodiment, realistic training areas in which only the objects to be touched by the training participants (for example doors and door handles in frames) are created in an actually tangible manner are set up in a cost-effective manner. This again allows free movement in virtual areas with simultaneous interaction.

The preferred embodiments can also be combined.

A very important advantage of the present invention is that the problems described at the outset are solved in a cost-effective and realistic manner with the cooperative interaction of opposing aims. Depending on the system variant, considerable costs can be saved when setting up and using training areas and providing corresponding performers during the training.

Furthermore, the invention enables the complete manipulation of the scenario and therefore further dynamic action sequences and training possibilities, for example strong weapon effects in the near field (explosion and destruction) and extreme injuries associated therewith.

The training participants are in a real accessible and interactive scenario and need not act at fixed positions in front of video screens, for example. There is no need for a further tracking method for determining the participant's position and viewing direction. This is inherent in the system and, as it were, self-adjusting in the system according to the invention.

According to the invention, the real image of the observer is replaced with the image generated by a computer with a display system. There are therefore no artefacts such as transparent and floating objects in front of the real background, as occur in display systems based on partially transparent mirrors, for example.

Unlike in video systems which replace objects using the known blue box method, the system described here can be used to change the image at any point in the area and not only in the colored regions predetermined for this purpose. In this case, the representation is dependent on the viewing angle and also has a vivid effect in the case of an extreme oblique view.

Since the virtual objects are not superimposed, as in the case of blue box effects for example, but rather are calculated into the real scenario and become part of the 3-D model, errors as a result of poor adjustment or incorrect divergence of the respective coordinate systems from the viewing direction tracking and overlay are also not produced.

An overview and an apparatus for carrying out the method according to the invention for simulating real combat operations in a scenario for training purposes with persons and at close range is described below and is explained using the figures.

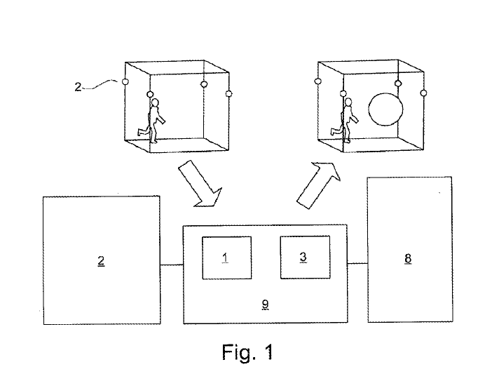

The top left of FIG. 1 illustrates a training area in which a training participant is situated. It goes without saying that more than one training participant may also be located in this training area. Individual objects of the scenario, for example other training participants, training items, weapons and the like, are not illustrated but are present.

The real actions in the training area, in which the training participants compete against one another with training weapons, are recorded during the training using an audio/video transmitting/receiving system 3 and are calculated as a 3-D model which changes in quasi real time using a computer system (not illustrated). In this case, a weapon effect is calculated by means of object recognition of the weapon, the state change and orientation during a shot either in the direction of a training participant, another item or another person or into space and by means of the objects in the effective direction and their injury models and is displayed using the computer system. For this purpose, microphones 2 are firstly installed in the training area and record the acoustics prevailing there. Images are also recorded using the system 3 which comprises the microphones. These images which are recorded using video cameras in the training area, for example, and the 3-D model which prevails in the training area and changes at any time on the basis of the training is calculated in quasi real time by means of the computer system 9 using the microphones 2.

The 3-D model calculated using the computer system is stored in a database 1 of the computer system 9. It can then be made available to the training participant by means of suitable reproduction, with the result that the training participant receives corresponding information relating to all states of the relevant individual objects of the scenario, such as participants, weapons, items of equipment, furniture and the like, in their intact, hit and destroyed states depending on the current status of the scenario. This has the advantage that the training participant no longer has to directly interact with the other training participants or objects of the scenario, but rather is provided with a purely virtual display of these real objects, which would be present per se in the training area, and can interact with said objects. This is illustrated by the training area at the top right of FIG. 1, in which case the sphere illustrated there is symbolic of the virtual representation of the real events which are now no longer present.

It is conceivable for the recording of the scenario using the audio/video transmitting/receiving system 3 to be controlled and/or monitored and/or observed by an observation system.

In order to make it possible for the participants to act virtually in the training area illustrated in FIG. 1, it is not only necessary first of all to present the respective training participant with the virtual scenario, which is stored in the database 1 and changes continuously, in a suitable manner but also, as a result of an interaction of the training participant's actions which must likewise be recorded, to provide the computer system 9 with information relating to where the respective training participant is situated inside the training area and how he interacts with the further training participants, opponents and objects present there.

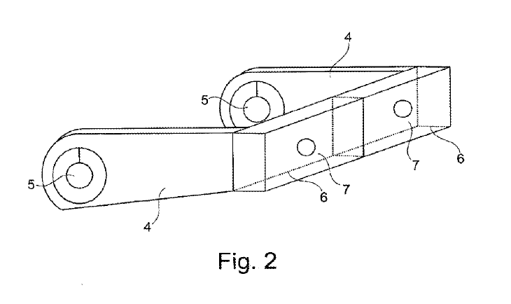

For this purpose, FIG. 2 illustrates a device which is in the form of glasses which can be worn by at least one participant, preferably each training participant. This device is configured as a wireless transmitting/receiving unit 4 for image and sound in the form of glasses with earphones 5 and a combination of suitable small and fast display systems 6 with video cameras 7 directed in the viewing direction. This unit to be worn by the training participant is constructed in such a manner that it blocks the view into the real scenario and hides the original noises during the training. This makes it possible for the respective training participant to be able to move freely in the training area and to generate a real scenario there on the basis of his movement, which scenario can be accordingly recorded, processed by the computer system 9 and stored in the database 1. At the same time, the computer system 9 acts in a corresponding manner with the unit in the form of glasses belonging to the training participant by integrating the virtual acoustic scenario there via the earphones 5 and via the display systems 7 and the video camera needed to record the scenario and the transmitting/receiving unit 4 needed to transmit data in a helmet. Alternatively, it is also conceivable to integrate the earphones 5, the display system 6 and the video cameras 7 in a pair of glasses and to connect them, via cables, to the transmitting/receiving unit 4 which then needs to be arranged at another position on the training participant, for example his clothing (for example a protective vest, a combat uniform or the like). This would have the advantage that an adequately dimensioned power supply for the elements 4 to 7 which would be disruptive in the training participant's head region could also be accommodated there.

It is likewise possible to envisage transmitting the information recorded by the microphones 2 and/or the video camera 7 to the computer system 9 not only wirelessly but also in a wired manner. In a particularly preferred embodiment, the microphones 2 are statically arranged in the training area and are wired to the computer system 9. Since the training participant moves in the training area, it is particularly advantageous to transmit the data between the participant and the computer system 9 wirelessly, preferably via radio.

The observation unit 8 is likewise connected to the computer system 9 for the purpose of transmitting data. It is therefore possible to present the real and/or virtual events of the scenario in the training area for an observer, and/or it is made possible for the observer to intervene in the events, for example by changing the data stored in the database 1. For this purpose, the observation unit 8 has accordingly configured reproduction apparatuses (for example screens) and/or accordingly configured input units (for example keyboards, joysticks or the like).

### LIST OF REFERENCE SYMBOLS

1. Database
2. Microphones
3. Audio/video transmitting/receiving system
4. Transmitting/receiving unit
5. Earphones
6. Display system
7. Video camera
8. Observation unit

1. A method for simulating real combat operations in a scenario for training purposes with persons and at close range, training participants competing against one another with training weapons and the real actions of the training participants during the training being recorded by imaging systems and being calculated as a 3-D model which changes in quasi real time, a weapon effect being calculated by means of object recognition of the weapon, the state change and orientation during a shot and the objects in the effective direction and their injury models, and being displayed, characterized in that, before the start of training, three-dimensional models of all relevant individual objects of the scenario in their intact, hit and destroyed states and animations of the corresponding state transitions including the associated acoustic effects are generated and stored in a database.

2. The method as claimed in claim 1, characterized in that the noises during the training situation are recorded in a surround sound recording method using at least one microphone, in particular a plurality of microphones, in the scenario.

3. The method as claimed in claim 1, characterized in that a computer system is used to carry out the method and this system is expanded with a multichannel audio/video transmitting/receiving system.

4. The method as claimed in claim 1, characterized in that the training participants additionally wear wireless transmitting/receiving units for image and sound in the form of glasses with earphones and a combination of display systems with video cameras directed in the viewing direction, and these device combinations are designed and used to block the view into the real scenario and to hide the original noises.

5. The method as claimed in claim 1, characterized in that the three-dimensional scenario model which is generated by one or more central computers and in which the training participants themselves move is displayed to the training participants in a tailor-made manner in terms of size and perspective and in real time using the display systems, and the matching sound effects for acoustic orientation are played in via the earphones in a surround sound method.

6. The method as claimed in claim 1, characterized in that the cameras worn by at least one training participant are used to additionally record the scenario directly in front of the trainee's eyes if the trainee himself conceals the scenario from the imaging system.

7. The method as claimed in claim 1, characterized in that the cameras are used as an aid in order to determine the trainee's viewing direction and to generate the corresponding view of the three-dimensional model in a tailor-made manner and to display it in a helmet display.

8. The method as claimed in claim 1, characterized in that, apart from the person to be trained, all other participants are completely represented by artificial performers and the latter are controlled by means of artificial intelligence according to the training objective and the trainee's action.

9. The method as claimed in claim 1, characterized in that realistic training areas are set up in a cost-effective manner by creating only the objects to be touched by the training participants in an actually tangible manner.

10. The method as claimed in claim 1, characterized in that the real image of the trainee is replaced with the image generated by a computer with a display system.
